(19) United States
(12) Patent Application Publication
(10) Pub. No.: US 2014/0291078 A1
(43) Pub. Date: Oct. 2, 2014

(54) BRAKE ASSEMBLY FOR A BICYCLE

(71) Applicant: John McIntyre, Traverse City, MI (US)

(72) Inventor: John McIntyre, Traverse City, MI (US)

(21) Appl. No.: 13/853,337

(22) Filed: Mar. 29, 2013

(51) Int. Cl. B62L 1/14

(52) U.S. Cl. CPC B62L 1/14
USPC 188/24.21

(57) ABSTRACT

A novel brake assembly is provided for a bicycle. The assembly is comprised of an arrangement of a pair of pulleys attached to braking arms with affixed brake pads leveraged against the bicycle rim. The braking power is accentuated by employing the two pulleys on the braking arms. A return spring causes the arms to return to non-braking position in response to the release of the braking cable.

### BACKGROUND OF THE INVENTION

The field of invention pertains to bicycle brakes and, in particular, to brakes which act upon the rim of bicycle wheels. Such brakes have been traditionally caliper brakes or cantilever brakes which both styles squeeze the rim of a bicycle between a pair of brake pads.

Caliper brakes may be single-pivot side-pull caliper brakes, dual-pivot side-pull caliper brakes, or center-pull brakes. Caliper brakes are usually less effective as tires get wider therefore reducing the brakes' mechanical advantage. As a consequence, caliper brakes are rarely found on contemporary mountain bikes. Calipers are ever present on road bikes, particularly the dual-pivot side-pull caliper brake with the single pivot style being found on inexpensive bicycles. Until the advent of dual pivot side-pull brakes, center-pull brakes were the option of choice and continued after the onset of more expensive side-pull brakes but have fallen out of favor.

Traditional cantilever brakes have an outwardly-angled arm protruding on each side, a cable stop on the frame or fork to terminate the cable housing, and a straddle cable between the arms. When the brake lever is applied, its cable pulls the straddle cable up causing the brake arms up and inward squeezing the rim between the brake pads, all very similar to center-pull caliper brakes. The side-pull cantilever equivalent to the side-pull caliper is the linear-pull brake such as Shimano's registered trademark V-brakes. This version of a cantilever brake has longer arms and the cable housing attached to one arm and the cable to the other. When the brake lever is applied, the cable is pulled the arms are drawn together similar to a caliper side-pull brake.

### SUMMARY OF THE INVENTION

With a view of increasing braking power to a cantilever linear-pull brake and reestablishing the center-pull caliper brake as a viable and inexpensive option to expensive side-pull caliper brakes, the invention aims at providing a simple structure for easy assembly and by its mechanical advantage offers increased power and new applications for the abovementioned bicycle brake types.

The new brake requires few parts and is relatively easy to manufacture with little need for adjustment after assembly.

Depending upon applying the various embodiments of the brake, the caliper version brake can be produced competitively with the added benefit of enhanced braking power over standard caliper brakes. On the contrary, the brake can be upgraded to compliment expensive road bikes utilizing more expensive construction materials with more attention to elaborate detail and finish.

The new brake is adaptable to some bicycles using cantilever brakes, specifically the linear-pull variety. The pulley feature located on both arms increases the braking effect when the brake lever is applied. However, the similarity to a side-pull caliper brake is now superseded.

The new brake shares many of the features of a caliper center-pull brakes such as having a spring to return both brake pads at rest and have common actuation and similar components such as a yoke and straddle cable. Also, the entire assembly mounts to a single point. The new brake design draws upon the extended arms of the cantilever linear-pull brake and compliments the mechanical movement of a cable pulling and drawing the arms together creating the braking action. As with existing art, all of the new brake components may be conveniently made from common materials.

Unlike the present caliper center-pull and cantilever linear-pull brakes, the new brake incorporates dual pulleys, and the later now has a center-pull configuration. Regarding the caliper embodiment of the invention, the new brake's resemblance to the letter “X” in design feature parallels the comparison to the letter “V” as with the cantilever linear brake design.

These and other features and advantages of the invention will become apparent from the detailed description below, in light of the accompanying drawings.

### BRIEF DESCRIPTION OF THE DRAWINGS

FIG. 1 is a front view of the caliper version new brake assembly in non-braking position with a portion of the bicycle frame or fork in the background.

FIG. 2 is a front view of the caliper version new brake assembly in braking position with a portion of the bicycle frame or fork in the background.

FIG. 3 is a front view of the cantilever version new brake assembly in non-braking position with a portion of the bicycle frame or fork in the background.

FIG. 4 is a front view of the cantilever version new brake assembly in braking position with a portion of the bicycle frame or fork in the background.

FIG. 5 is a close-up view of the new brake assembly pulley mechanical movement.

FIG. 6 illustrates details of the new brake assembly straddle cable features.

For purposes of clarity and brevity, like elements and components will bear the same designations and numbering throughout the Figures.

### DESCRIPTION OF THE PREFERRED EMBODIMENTS

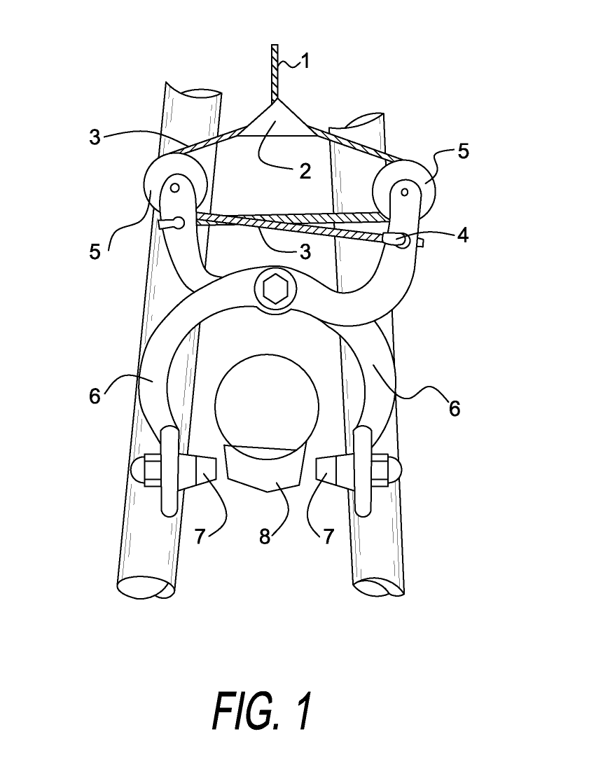

Referring to FIG. 1, the caliper version new brake assembly in non-braking position is shown with brake pads 7 at rest and not in contact with the wheel rim 8. Also shown is the brake control cable 1 is attached to the yoke 2 which is connected to the straddle cable 3 with straddle cable directed through the pulleys 5. The straddle cable 3 has stepped ends 4 that slide through and lock in place in the brake arms 6.

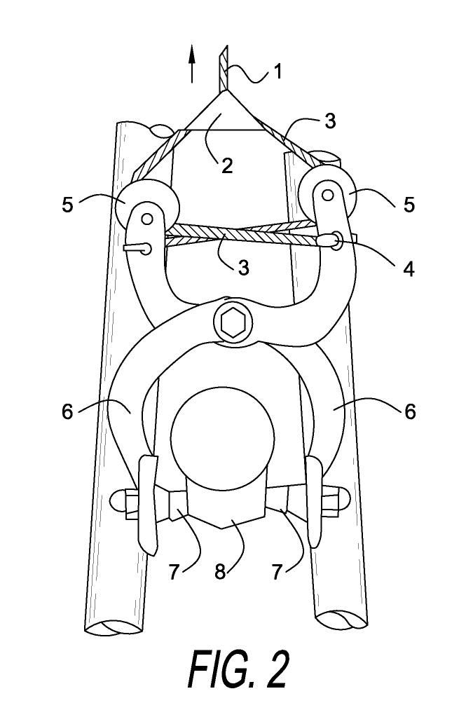

Referring to FIG. 2, the caliper version new brake assembly in braking position is shown with brake pads 7 making contact with the wheel rim 8. Also shown is the brake control cable 1 actuated with the yoke 2 raised which tightens the straddle cable 3 with cable traveling through the pulleys 5 leveraging the brake arms 6 and associated brake pads 7 making frictional contact with the rim 8.

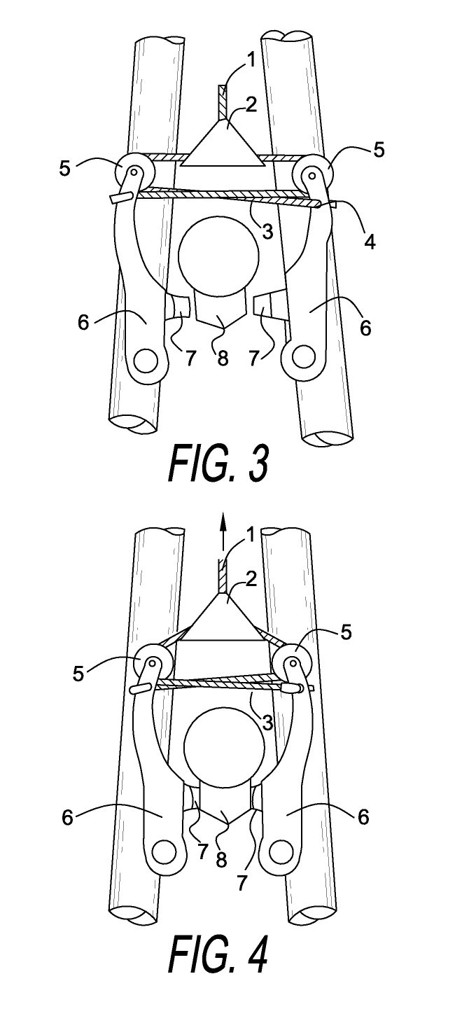

Referring to FIG. 3, the cantilever version new brake assembly in non-braking position is shown with brake pads 7 at rest and not in contact with the wheel rim 8. Also shown is the brake control cable 1 is attached to the yoke 2 which is connected to the straddle cable 3 with cable directed through the pulleys 5. The straddle cable 3 has stepped ends 4 that slide through and lock in place in the brake arms 6.

Referring to FIG. 4, the cantilever version new brake assembly in braking position is shown with brake pads 7 making contact with the wheel rim 8. Also shown is the brake control cable 1 actuated with the yoke 2 raised which tightens the straddle cable 3 with cable traveling through the pulleys 5 leveraging the brake arms 6 and associated brake pads 7 making frictional contact with the rim 8.

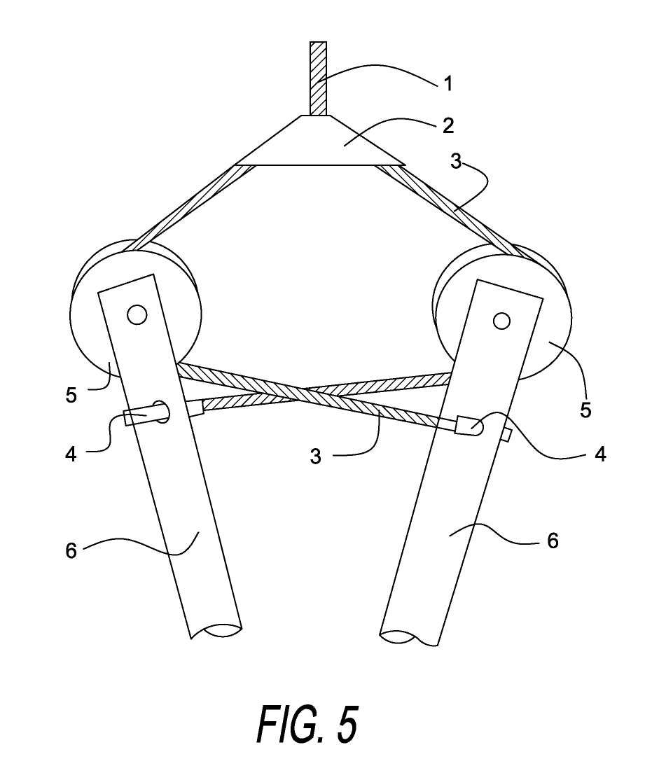

Referring to FIG. 5, shows the brake control cable 1 is attached to the yoke 2 which is connected to the straddle cable 3 with cable directed through the pulleys 5. The straddle cable 3 has stepped ends 4 that slide through and lock in place in the brake arms 6.

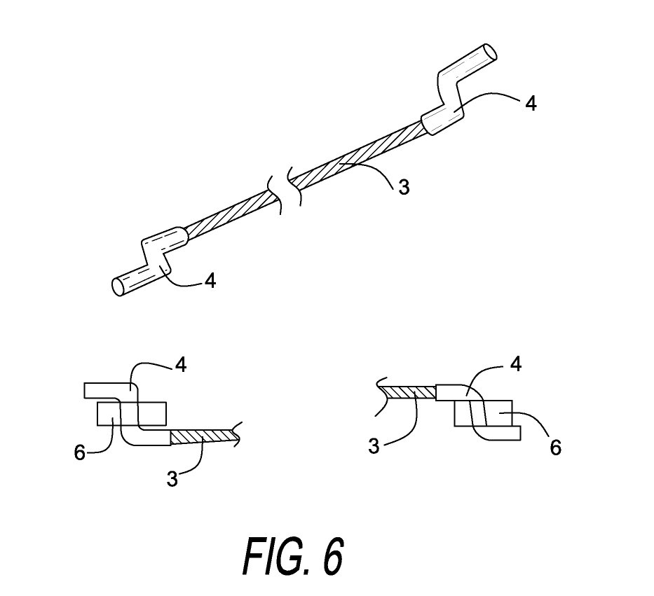

Referring to FIG. 6, illustrates the one piece straddle cable 3 having ends 4 positioned that after soldering onto the cable have ends facing opposite of each other. When the new brake is fully assembled, this offset is to lessen frictional contact with the cable when employed. This is further illustrated by showing the section of the brake arms 6 with straddle cable stepped ends 4 protruding therein to in the correct assembled position.

Having thus described the invention, what is desired to be protected by Letters Patent is presented in the subsequently appended claims.

The invention claimed is:

1. A bicycle brake comprising:
a pair of brake arms rigidly fixed to a bicycle,
a pair of pulleys with one mounted on each brake arm,
a straddle cable with ends connected to each of the opposing brake arms with movement simultaneously causing the brake arms to have frictional engagement with a bicycle wheel.

2. A bicycle brake of claim 1 wherein the straddle cable connected to each of the opposing brake arms have stepped ends that permit location though and locking into the brake arms.

3. A bicycle brake for applying a squeezing force to retard movement of a bicycle wheel, comprising:
a pair of opposed brake arms,
means for each arm for frictionally engaging a bicycle wheel, said frictionally engaging means movable between a non-braking and braking position, and
a set of pulley members and straddle cable to direct the relative movement of the frictionally engaging means to the bicycle wheel movement.
